(19) United States
(12) Patent Application Publication
(10) Pub. No.: US 2012/0200793 A1
(43) Pub. Date: Aug. 9, 2012

(54) 3-D Cinema and Display Technology

(76) Inventor: Hossein Tajalli Tehrani, Austin, TX (US)

(21) Appl. No.: 13/362,355

(22) Filed: Jan. 31, 2012

Related U.S. Application Data
(60) Provisional application No. 61/462,250, filed on Jan. 31, 2011.

(51) Int. Cl. G02F 1/1335; G02B 27/22

(52) U.S. Cl. 349/15; 359/466

(57) ABSTRACT

The purpose of this invention is to producing a 3-D image data on projection screens or flat panels such as LCD. This invention will allow multiple viewers to watch the projected images without special eye-glasses. The invention is based on Polarization Encoding and Synchronization Systems which allow right and left eye images to be projected sequentially. Components of this invention are: (1) Image-Separator Glasses; (2) Shutter Panel, (3) Two high-speed cameras; (4) Display device; (5) A Commander Unit; (6) Polarizer Unit, and (7) Polarized Coded Image-Separator Glasses.

This application claims priority to U.S. provisional application 61/462,250, filed on Jan. 31, 2011.

### SUMMARY

The purpose of this disclosure is to provide a description of producing a 3-D image data on projection screens or flat panels such as LCD. This invention will allow multiple viewers to watch the projected images without special eye-glasses. The invention is based on Polarization Encoding and Synchronization Systems which allow right and left eye images to be projected sequentially. Components of this invention are: (1) Image-Separator Glasses; (2) Shutter Panel, (3) Two high-speed cameras; (4) Display device; (5) A Commander Unit; (6) Polarizer Unit, and (7) Polarized Coded Image-Separator Glasses.

The Image-Separator Glasses function is to direct viewer's eye-sight into two different pathways; the sight from the right eye will go through designated right-eye “Strip Bands” while sight from the left-eye will go through designated left-eye “Strip Bands”. As a result, each eye of the viewer will see the screen through an array of “Strip Bands” different than the other eye.

The Shutter Panel is a Liquid Chrystal flat panel. This is a modulator optical glass. The panel includes an array of thin vertical strips. Each strip is called “Shutter Strip”. There are two types of “Shutter Strips” in the “Shutter Panel”; Strips designated for the right-eye and Strips that are designated for the left-eye. The right and left eye “Shutter Strips” are placed vertically side-by-side alternatively. The right and left eye arrays of “Shutter Strips” turn On and Off alternately. The On strips will allow only one of the eyes to see the designated pictures while the other eye does see anything. The Off and On alternate for the two eyes.

Two High-Speed cameras are used to record the same image from two different angles.

Display Device is mounted behind the Image-Separator Glass and the Shutter Panel. It displays the right and left images sequentially. There are different types of Display devices; flat device (such as LCD), and Projection screen (such as cinema).

Commander Unit is an electronic device which controls the timing operation of the Display Device, Shutter Panel, and polarizer unit.

Polarizer Unit polarizes the right and left eye images in opposite patterns of each other.

Polarized Coded Image-Separator Glasses is a type of image-separator glass that its strip-bands, on its rear surface, are alternately polarized coded in opposite patterns of each other. The main function of this device is to decode the right-eye image data and redirect them to the right eye of the viewer. Similarly, the left-eye image data are decoded and transmitted only to the left-eye of the viewer.

The Synchronization system is the process by which ‘Image Separator Glass’ and ‘Shutter Panel’ operate. This system acts as a traffic director for sending and regulating the right and left eye images that are projected by display device to the appropriate eye of the viewer.

The Polarization System is the process by which the polarized coded lines of the right-eye images are made in opposite directions of the polarized coded lines of the left-eye images. As a result, right eye of viewers see only the coded images designated for the right eye while the left-eye of the viewers see only the coded images that are meant for the left eye. When brain combines these distinct images that are transmitted through the eyes, it creates an illusion of three-dimensional image data that has depth.

### BRIEF DESCRIPTION OF THE DRAWINGS

FIG. 1 is a set of multiple views of an Image Separator Glass.

FIG. 2 is a set of multiple views of a Lens.

FIG. 3 is a view of a Synchronization System embodiment of the present invention.

FIG. 4 is a view of a Polarize System embodiment of the present invention.

FIG. 5 is a set of multiple views of components used in one embodiment of the present invention.

FIG. 6 is another view of a Synchronization System.

FIG. 7 is another view of a Synchronization System.

FIG. 8 is another view of a Synchronization System.

FIG. 9 is another view of a Polarize System.

FIG. 10 is another view of a Polarize System.

FIG. 11 is another view of a Polarize system.

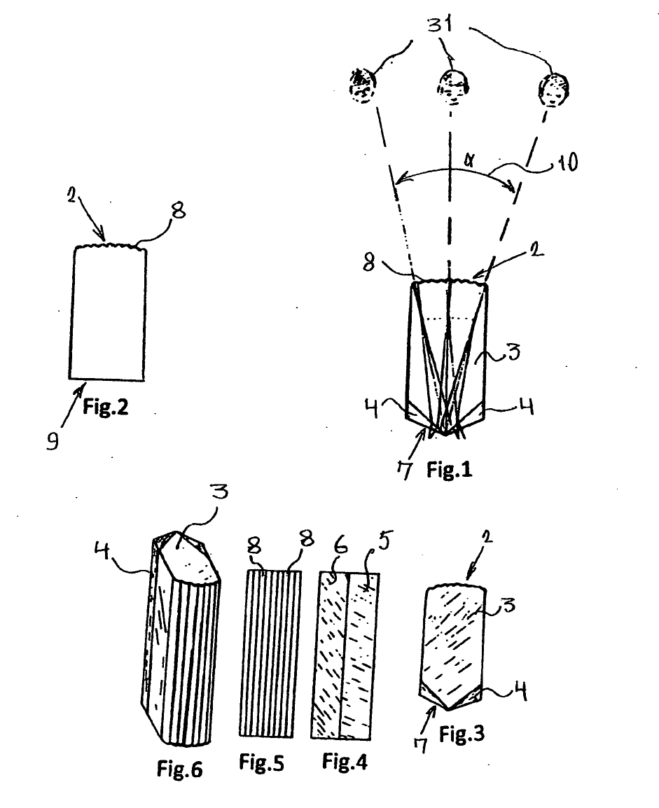

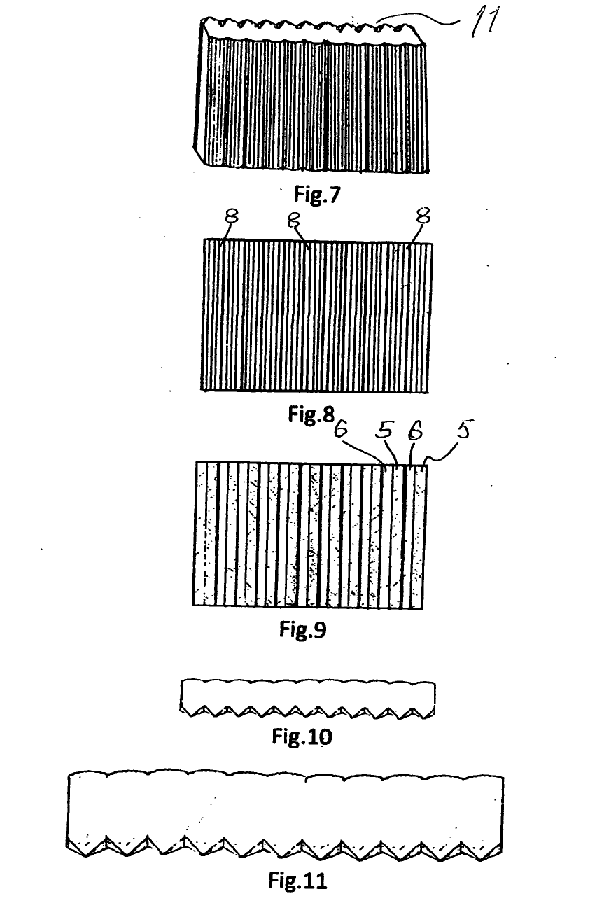

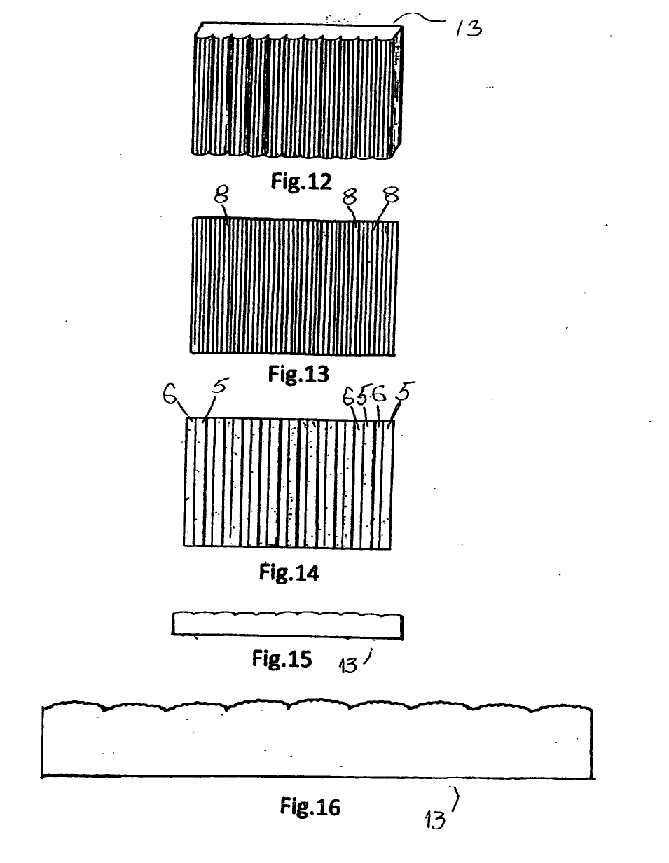

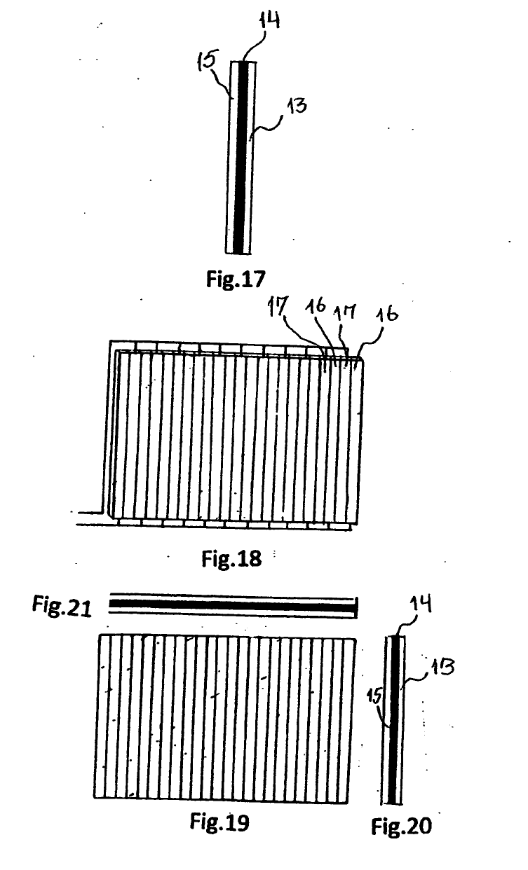

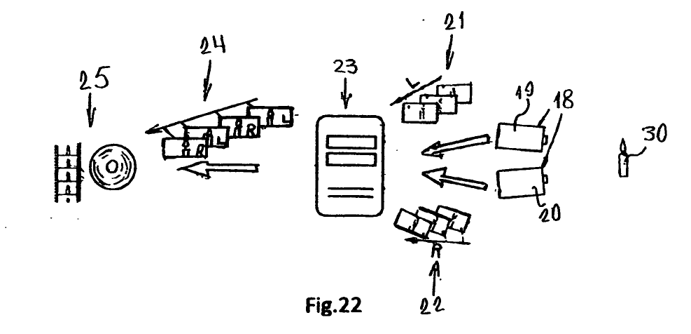

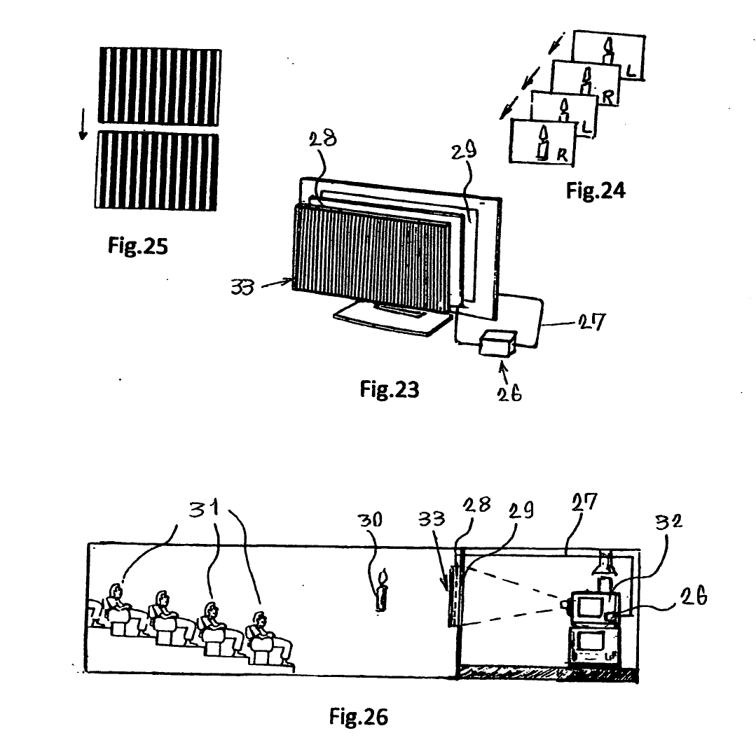

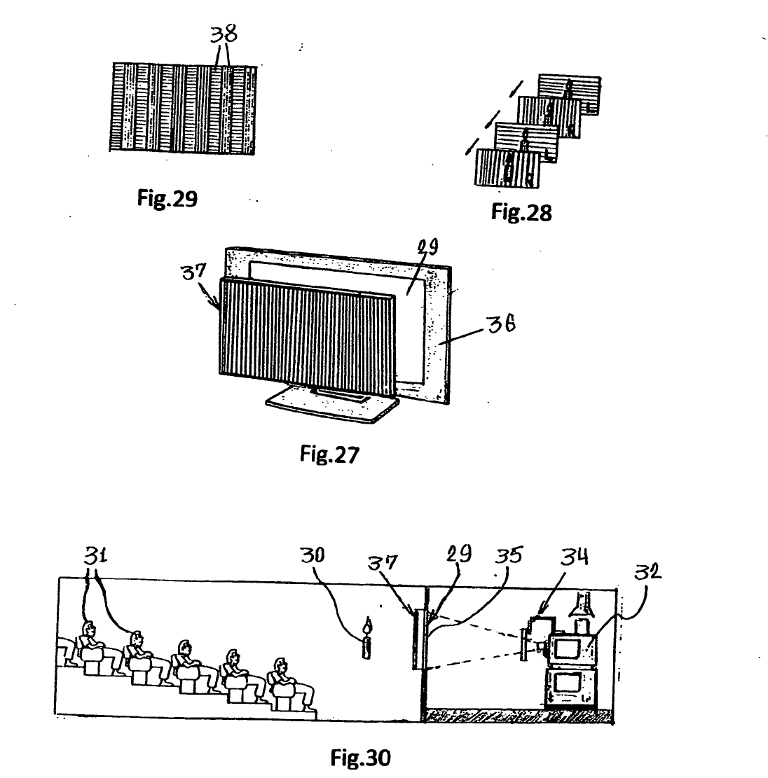

### INTRODUCTION

The present invention relates to auto-steroscopic motion picture and flat panel display technology. This invention provides different technologies in order to produce 3-D moving images for simultaneous view by several observers without using eyeglasses.

Three dimensional visualization and perception of dept in our brain is affected by the way our left and right eyes observe objects. Left and right eyes view objects from different angles. The two pictures observed by our eyes are fused together in our brain to create a unified picture that has dept. The present invention replicates this process via a combination of different methods; Synchronization and Polarization systems. The following section will begin by describing the structure and operation of the main component of this invention (i.e., Image Separator Glass) followed by description of how Synchronization and Polarization processes work in this invention.

### Image Separator Glass

This is a flat layer of optical glasses consisting of an array of semi-cylindrical fine vertical lens called ‘Multi-cular lens’. The lens is made of crystal clear and 100% light transparent material. The lens is made of a special glass or plastic. The lens consists of two parts—front and the rear parts. Front part is semi-cylindrical liner lens as shown on FIG. 1. It is made of crystal clear light-transparent material different than rare part. The front part of the lens has less material density and less light-bending optical power than the rear part of the lens.

The rear part of the lens is also semi-cylindrical structure but different than the front part. It is an anamorphic fine liner lens with non-zero thickness and light diverging optical power. Similar to the front part, this part is also made of crystal clear light-transparent material but with lighter density and stronger light-bending optical power than the front part.

The rear and front part adjust and fit together and they perform in harmony as a single optical unit. The Multi-cular lens unit has two surfaces—the front surface and the rear surface. The front surface has a convex shape. The surface is not smooth rather composed of numerous curves with semi-circular or semi-elliptical shapes. The curves are adjacent to each other with no gaps in between. Each of these curves is responsible for covering a portion of the viewing angle.

The rear surface is not flat either. It is also convex shape but with a smooth surface. The rear surface is divided into two identical strips or bands. One of the bands is designated for the left-eye of the viewer and the other band is for the right eye of the viewer.

### How the Multi-Cular Lens Works

After crossing the front surface of the lens, the shape and structure of the lens directs the viewer's sight into two different pathways. The sight from the right-eye will go through the designated part of the rear surface while the sight from the left-eye will go through the second part of the rear surface.

The function of the rear part of Multi-cular lens is to widen the lens's viewing angle for observing a larger area on a display screen. The length of the focal point of this lens is equal to the thickness of the lens. The viewing angle of each Multi-cular lens is greater than 30 degrees. When several of these lenses are vertically positioned next to each other they will form an array of Multi-cular lenses. The array forms a flat layer of glass called ‘Image Separator Glass’. The center-to-center distances of all individual Multi-cular lenses that from ‘Image Separator Glass’ are equidistant. Each Multi-cular lens has two ‘strip-bands’ on its rear surface. One of the strip-bands is designated for the left-eye and the other is for the right-eye. Therefore, the ‘Image Separator Glass’ has two different sets of strip-bands in its rear surface—the left-eye strip-bands and the right-eye strip-bands. The right and the left eye strip-bands alternatively cover the entire back surface of the ‘Image Separator Glass’.

The function of the ‘Image Separator Glass’ is to redirect right and left eye strip-bands images to the appropriate eye of the viewer. As a result, when the glass is mounted on a display screen the image can be viewed in 3-D mode. Multiple viewers of the image can simultaneously have the same 3-D experience.

### Synchronization System

The synchronization system of the present invention provides method, approach, devices and combination for generating and displaying 3-D moving images to be seen simultaneously by multi-viewers without the use of special glasses. The system has several components as follows:

1) Two High-Speed Digital cameras/or one dual-lens High-Speed Digital camera

2) A Digital Display Device

3) A Commander Unit

4) The ‘Shutter Panel’

5) The ‘Image Separator Glass’

Each of these components is described below.

Cameras: The two digital cameras are separated by the distance of 2½ inches for recording movements. The cameras shoot each image from two different viewpoints; one representing the viewpoint of the right eye and the other representing the viewpoint of the left eye. The two images are ultimately transmitted to a computer that places them alternately one after another. The alternated images are placed on a CD, a film or a storage device.

Digital Display Device: The display device, in the present invention, can be a flat-panel display (such as LCD) or projection screen (such as cinema). The display device displays the image data sequentially for the right and the left eyes. The sequential timings are controlled by the Commander unit.

Commander Unit is an electronic device in the display device which is connected by wire line to the display device, ‘Shutter Panel’, image data provider source and other main components of display device. The commander unit's function is to coordinate operating time of all components including the ‘Shutter Panel’. This timing is based on the right and left eye images that are shown sequentially on the display device.

The ‘Shutter Panel’ is a liquid crystal flat-panel modulator optical glass device made of three layers: first, the transparent substrate layer, second, the transparent substrate layer and finally the liquid crystal cell layer supported between the first and second layer.

‘Shutter Panel’ includes an array of thin vertical strips. Each strip is called a ‘Shutter Strip’ and includes three layers: two transparent substrate layers and a polarity of liquid crystal cell area layer that is placed between the two transparent substrate layers. In the first transparent substrate layer the first transparent electrode is formed and in second transparent substrate layer the second transparent electrode is formed. Each ‘Shutter Strip’ unit is turned ‘ON’ and ‘OFF’ by electro-signal inputted from the Command Unit. An ‘ON’ and ‘OFF’ electro-signal is supplied to the second transparent electrode layer and the reference electro-voltage is applied to the first transparent electrode layers. When the ‘ON’ electrode-signal is supplied to the second transparent electrode liquid crystal cell areas ‘Shutter Strips’ go into the state of light transparency and when the ‘OFF’ signal is supplied to the second transparent electrode liquid crystal ‘Shutter Strip’, the strip goes to state of dark, in other words it does not permit light to pass.

There are two types of ‘Shutter Strips’ in the ‘Shutter Panel’: shutter strips designated for the right eye and shutter strips designated for the left eye. The right and left eye shutter strips are placed alternately side-by-side vertically. The center to center distance of the adjacent shutter strips are exactly the same. Similarly, shape, size, thickness and surface area are all exactly the same.

The ‘Shutter Panel’ has two flat and smooth surfaces, rear and front surface. ‘Image Separator Glass’ is mounted on the front surface of the ‘Shutter Panel’. ‘Image Separator Glass’ and ‘Shutter Panel’ are mounted on each other in such a way that the right-eye designated ‘Shutter Strips’ of the ‘Shutter Panel’ are matched with the right-eye designated ‘Strip Bands’ of rear surface of the ‘Image Separator Glass’. Similar matching is done for the left-eye designated ‘Shutter Strips’.

The Commander Unit alternately turns the array of left and right eyes ‘ON’ and ‘OFF’ according to the right and left-eye synchronization of image data update of the display device. This process blocks improper image data from one eye and the next, and let each eye of viewer see only appropriate image data on display device.

The Commander Unit sends electro-signal via wire line, controls and coordinates timing operation of the ‘Shutter Panel’ and display device based on frame frequency of 120 Hz or higher.

### How the Synchronization System Works

The process involves shooting and recording of moving images by two cameras (or one camera with a dual lens). The two cameras record the same moving image simultaneously but at two different angles. To do so, the cameras are place about 2½ inches apart when filming. Recordings of each camera correspond to one of the eyes (right and left eyes). The resulting films from the two cameras are merged into one continuous film or CD using computer. Merging is done in such a way that the corresponding frames of the same image are placed either side by side or one right after the other. The resulting film or CD facilitates the 3-D viewing of the images when projected from the behind of a screen or a viewing panel that are covered by ‘Shutter Panel’ and ‘Image Separator Glasses’. Viewers will see images displayed on the screen through the ‘Shutter Panel’ and ‘Image Separator Glasses’.

The two glasses mounted on the viewing panel act as traffic directors. Together, alternately they direct images to the right and the left eyes of the viewers at a specified speed. The two glasses mounted on the screen perform two different functions in this process. The ‘Image Separator Glasses’, which is the nearest to the viewer, directs right-eye images to the right-eye and the left-eye images to the left eye. The glass between the ‘Image Separator Glasses’ and the screen is the ‘Shutter Panel’. The right and left designated ‘Liquid Crystal Strips’ of the ‘Shutter Panel’ alternately go on and off. When the right-eye images are projected, the right-eye L-C strips go on and the left-eye L-C strips go off. Therefore the viewer sees only the right-eye images with their right eye. Conversely, when the left-eye images are projected, the left-eye L-C strips go on while the right-eye L-C strips go off. In this instance, only the left-eye images are seen by the left eye of the viewer. The resulting process is that the viewer alternately sees the right and left images that are projected through the viewing panels.

It should be noted that the right and left eye images are slightly different from each other because they were recorded by two different cameras at two different angles. When these images are shown to the viewers at specified rapid frequencies, the viewer perceives the images as unified images. Juxtaposition of the two images in the mind of the viewers will create an illusion of a 3-D picture.

### The Polarize System

The present invention can also be adapted to Polarize system. The polarize technology of the present invention produces a three-dimensional, moving images without a need for wearing 3-D eye glasses. This technology involves the following components:

1) Two High-Speed Digital cameras (or one dual-lens camera)

2) A Digital Display Device

3) A Polarizer Unit

4) Polarize Coded Image Separator Glass.

The cameras and the digital display device are described earlier. Below, the description of the last two items will be presented.

The Polarizer Unit: This device is connected to a control computer of a projector. The device polarize code right and left eye image data in opposite patterns.

Polarize Coded Image Separator Glass: This device contains an array of strip bands on its rear surface. These bands are alternately polarize-coded opposite of each other. Each alternating polarized band is designated for one of the eyes. The main function of this invented technology is to decode the right eye images and redirect the image to the right eye of the viewer. Similarly, the left eye images are decoded and transmitted only to the left eye of the viewer.

### Polarization System

How the “Polarize System” Technology of the Present Invention Works The process involves shooting and recording of moving images by two cameras. The two cameras record the same moving image simultaneously but at two different angles. To do so, the cameras are placed about 2½ inches apart when filming. Recording of each camera corresponds to one of the eyes (right and left eyes). The resulting image frames from the two cameras are merged into one continuous film, CD or a data storage device. Merging is done in such a way that the corresponding frames of the same image are placed one after the other. The resulting film or CD facilitates the 3-D viewing of the images. Before the images are shown by the display device, they go through the polarization process. This process takes place in an intervening of polarizer unit. The unit functions as a switch polarizing the incoming right and left images in opposite directions. When the polarized images are shown by the display device that has the polarized coded ‘Image Separator Glass’, the viewers will see 3-D images. The reason is that each eye of the viewer will see through “Strip Bands” coded in opposite direction lines, different than the other eye. As a result, right eye of the viewer sees only the decoded images designated for the right eye while the left eye of the viewer sees only the decoded images that are meant for the left eye. When brain combines these distinct images that are transmitted through the eyes, it creates an illusion of three dimensional moving images that have depth.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the claims.

What is claimed is:

1. A semi-cylindrical transparent vertical lens for a 3-D imaging system, said lens having a focal point, a viewing angle, a front part, a rear part, a front surface a rear surface, means for directing a viewer's sight into two different pathways such that the sight from a viewer's right-eye will go through a designated part of the rear surface while the sight from a viewer's left-eye will go through the second part of the rear surface, and means for widening the lens's viewing angle.

2. The vertical lens of claim 1, wherein:
said front part has a semi-cylindrical shape, and a lower material density and lower light-bending optical power than said rear part of said lens,
said rear part has an anamorphic liner lens feature with non-zero thickness and light diverging optical power,
said front surface has a convex shape and comprising a plurality of curves with semi-circular or semi-elliptical shapes,
said rear surface has a convex shape and two strip bands.

3. The vertical lens of claim 1, wherein:
the length of the focal point is equal to the thickness of the lens.

4. The vertical lens of claim 1, wherein:
the viewing angle is greater than 30 degrees.

5. A modulator optical glass device for a 3-D imaging system, having a first transparent substrate layer, a second transparent substrate layer, and a liquid crystal cell layer supported between said transparent substrate layer and said second transparent substrate layer.

6. The modulator optical glass device of claim 5, having an array of shutter strips, each shutter strip comprising a first transparent substrate layer, a second transparent substrate layer and a liquid crystal cell area layer supported between said first and second transparent substrate layers.

7. The modulator optical glass device of claim 6, wherein said first transparent substrate of each shutter strip forms a first transparent electrode and said second transparent substrate of each shutter strip forms a second transparent electrode.

8. The modulator optical glass device of claim 7, wherein a shutter strip is transparent when a reference electro-voltage is applied to said first transparent electrode layer and an “on” electrode-signal is supplied to said second transparent electrode.

9. The modulator optical glass device of claim 7, wherein a shutter strip is transparent when a reference electro-voltage is applied to said first transparent electrode layer and an “off” electrode-signal is supplied to said second transparent electrode.

10. The modulator optical glass device of claim 6 comprising a set of shutter strips designated for the left-eye and a set of shutter strips designated for the right-eye, said sets of shutter strips alternating side-by-side.

11. The modulator optical glass device of claim 5 comprising a plurality of semi-cylindrical transparent vertical lenses according to claim 1 mounted to the front surface, each of said plurality of transparent vertical lenses designated for the right eye, or the left eye in an alternating pattern, mounted such that said shutter strips designated for the right-eye are matched with said strip bands designated for the right eye, and said shutter strips designated for the left eye are matched with said strip bands designated for the left eye.

12. A polarizer unit for a 3-D imaging system, comprising a plurality of semi-cylindrical transparent vertical lenses, comprising means for coding right and left eye image data in opposite patterns.

13. The polarizer unit of claim 12, wherein:
each said lens has a front part a rear part, a front surface and a rear surface,
said front part has a semi-cylindrical shape, and a lower material density and lower light-bending optical power than said rear part of said lens,
said rear part has an anamorphic liner lens feature with non-zero thickness and light diverging optical power,
said front surface has a convex shape and comprising a plurality of curves with semi-circular or semi-elliptical shapes,
said rear surface has a convex shape and two strip bands, and wherein said strip bands are alternately polarized in an opposite pattern line according to left eye image data and right eye image data, such that right eye image data is directed to the right eye of a viewer, and left eye data is directed to the left eye of a viewer.

14. A polarizer unit according to claim 12, having a flat panel shape and mounted in front of a monitor.

15. A polarizing system for 3-D display comprising means for switch polarizing incoming right and left images in opposite directions, means for directing decoded images to a viewer's left eye, and means for directing decoded images to a viewer's right eye.

16. The polarizing system of claim 15, comprising a polarized coded image separator glass.

17. A synchronizing system for 3-D display comprising means for alternately displaying images designated for a viewer's right eye and images designated for a viewer's left eye.

18. The synchronizing system of claim 17, wherein images designated for a viewer's right or left eye are merged either side by side or one right after the other.

19. The synchronizing system of claim 17 comprising an image separator glass, a shutter panel, a plurality of left eye liquid crystal strips, and a plurality of right eye liquid crystal strips, wherein: when said left eye and right eye liquid crystal strips are alternately turned on and off, a viewer is capable of seeing images designated for the viewer's left eye and right eye respectively.

20. The synchronizing system of claim 17, wherein images designated for a viewer's right eye and images designated for a viewer's left eye are prepared by recording the same object with two different cameras at two different angles.
